(19) United States
(12) Patent Application Publication
(10) Pub. No.: US 2015/0261011 A1
(43) Pub. Date: Sep. 17, 2015

(54) Method and Apparatus for Preparing Gradient Polarization Sheet

(71) Applicants: Giorgio Trapani, Cambridge, MA (US); Robert K. Tendler, Chestnut Hill, MA (US)

(72) Inventors: Giorgio Trapani, Cambridge, MA (US); Robert K. Tendler, Chestnut Hill, MA (US)

(21) Appl. No.: 14/215,276

(22) Filed: Mar. 17, 2014

(51) Int. Cl. G02C 7/12; G02C 7/10; G02B 5/30

(52) U.S. Cl. CPC G02C 7/12; G02B 5/3033; G02C 7/105

(57) ABSTRACT

A method and apparatus for continuously forming a web having a gradient polarization characteristic for use in sunglasses or other optical applications includes drawing a vertically oriented web of molecularly oriented material through a dye bath at an angle to the bath such that the residency time in the bath varies from top to bottom of the web to establish a polarization gradient from 100% at the top of the web to close to 0% at the bottom of the web. This process also creates a minimum transmissivity at the top of the web and a maximum transmissivity at the bottom of the web for permitting viewing displays using sunglasses having lenses cut from the web by viewing a display through the bottom portion of the sunglass lenses.

### FIELD OF THE INVENTION

This invention relates to polarized sunglasses and more particularly to a method and apparatus for creating a gradient polarized sheet for use in sunglasses and other optical applications.

### BACKGROUND OF THE INVENTION

As illustrated in U.S. Pat. No. 7,374,282 issued to Robert K Tendler on May 20, 2008, gradient polarization sunglasses are useful in order to be able to view a scene at a distance through the polarized lenses, whereas viewing a polarized display is difficult due to cross polarization that would blacken out the display. This patent describes that by providing a gradient polarization for the sunglass lenses with maximum polarization at the top and zero polarization at the bottom that one can view polarized displays by looking through the unpolarized portion of the sunglass lenses so that no cross polarization occurs.

In this patent the provision of the gradient polarized sheet is done by differential stretching and orientation of the substrate utilized in forming the polarized film. However, such a technique is so difficult to implement.

There is therefore need to provide a gradient polarized sheet for use in sunglasses which is easily manufacturable on a continuous basis.

A technique discussed in U.S. Pat. No. 4,190,418 issued to Harold O Buzzell Feb. 26, 1980 describes a system for preparing a gradient dyed sheet that in essence provides varying darkness or optical density across the sheet. In the application discussed in this patent, already polarized films are provided with an overcoated dye across the web transverse to its longitudinal dimension in which the optical density of the overcoat varies from the top of the sheet to the bottom.

In the process of providing a dyed web in a continuous manner, in this patent a carrier sheet is introduced into a bath of dye at an angle and pulled longitudinally through the dye such that the bottom part of the web is subjected to the dye for a longer period of time than the top portion of the web. When the web is passed through the dye the result is that the bottom portion of the web is deeply dyed, whereas as one goes upward vertically, the web is less and less densely dyed. This provides the optical density gradient, in this a darker portion at the top of the lens.

As described, this patent invention relates to the applying of dyes to webs to obtain a smoothly changing gradation in the amount of dye present on the web which is a function of the distance from a specified edge of the web. It is noted that the method and apparatus described in this patent refers to dying a web in a continuous manner so as to impart a dye density gradient to the web across the narrow or transverse direction of the web. It is also said that this web may be then cut into lens blanks.

While this patent refers to the ability to create a dye density gradient across the face of a continuously moving web, it does not address the problem of providing a gradient polarization characteristic across a polarized sheet. The dyes described in the aforementioned patent are primarily those associated with providing color or darkness filtering for lenses and do not in and of themselves provide a gradient in the degree of polarized characteristic to the oriented sheet. For uniformly polarized sheets either iodine or dichroic dyes are utilized in a bath in which a film or sheet is immersed such that through the chemical association of the molecules of the dye with the molecules of the oriented sheet, molecule orientation associated with the oriented sheet is imparted to the resulting dye sheet molecules, thus to provide the required polarization.

The manufacture of polarized sheets in this manner is quite well known. However there is no attempt to provide a gradient polarization effect from one edge of the sheet to the another edge of the sheet. Rather the polarization imparted to the sheet by submersing the sheet in a bath is a uniform polarization such that the polarization is close to 100% across the entire sheet.

There is therefore need to provide a polarized sheet which has a polarization gradient such that at the top edge of the sheet the polarization is close to 100%, whereas at the bottom of the sheet the polarization is close to 0%. If such a sheet could be manufactured, especially in a continuous process, then the sheets could be cut out for lenses, with the cut out sheets providing gradient polarized material sandwiched between two lens caps to form a sunglass lens.

When sunglasses are made with such a gradient polarized layer, when viewing a scene in the distance it is viewed as a polarized scene, whereas when glancing down through the unpolarized portion of the lens a polarized display will be viewed without cross polarization darkening of the display. This means displays on iPhones, smart phones, tablets and computer screens as well as instrument displays and the like may be viewed by looking through gradient polarized lenses by glancing downwardly through the unpolarized portion of the lens.

### SUMMARY OF THE INVENTION

Rather than using the Buzzell technique for varying the darkness of the sheet in an unoriented random fashion in which the dyes are not oriented, in the subject invention, a system is provided for continuously creating a web of polarized material in which the dyes are oriented and in which the polarization characteristic of the material varies from a top edge of the material to the bottom edge of the material, with the top edge of the material being close to 100% polarized and with the bottom edge of the material being close to 0% polarized. This is accomplished by providing a dye such as iodine or a dichroic dye in a bath and providing a web that is vertically oriented with respect to the surface of the bath. This vertically oriented web is introduced at an angle down through the bath such that when the web is pulled horizontally through the bath the lower portion of the web is a exposed to the dye for a longer period of time than is the top portion of the web. The angle of the web with respect to the horizontal surface of the dye as well as the pulling speed of the web through the dye is controllable so as to control the amount of dye material that is deposited on the oriented web. Note, the particular dyes used become aligned with the oriented material to absorb light in an anisotropic manner, thus to provide the polarization characteristic. With less dye existing at the bottom of the web, the amount of polarization is likewise less.

By so doing, a continuous web can be produced which has a continuous polarization gradient, with polarization being greatest at the top edge of the sheet and gradually reducing to the bottom edge sheet. When this gradient polarized sheet is cut and used for polarized lenses, the sunglasses are provided with the gradient polarization described above.

It will be appreciated that polarized light when passing through a polarized sheet is attenuated to the extent that there is cross polarization between the linearly polarized light impinging on the sheet and the polarization direction of the sheet itself. This polarization effect darkens the viewed seen due to the reduction of the polarized light through the polarized sheet.

Not only is the degree of polarization varied in the subject application, so too is the transmittance of light in general. It will be noted that when viewing a polarized display with traditional polarized sunglasses, the display itself is darkened to the degree that the polarized light from the display is cross polarized with the polarization sheet used in the sunglasses. This in some cases prohibits viewing the polarized display, with the darkening due to the cross polarization.

On the other hand by providing a gradient polarized sheet, not only is the polarization degree or characteristic changed from the top of the sheet to the bottom of the sheet, so is the amount of dye deposited on the oriented sheet. Since one of the goals is to be able to view a display through sunglasses, by reducing the amount of dye deposited on the oriented sheet from top to bottom, the sheet at the bottom is basically transparent such that there is no darkening of the display when viewing the display through the bottom of the sunglass lenses.

This means that a pair of sunglasses that can be worn all the time and yet be usable to view polarized displays or indeed any display through the bottom of the sunglasses without removing the sunglasses. This is because not only is the polarization characteristic nonexistent at the bottom of the sunglass lens, also the transmissivity of the lens at the bottom of the lens is maximum meaning that it is virtually clear and does not attenuate any part of the light coming from the display This occurs whether the display is polarized not.

The obvious advantage is that one can utilize one's sunglasses to view any kind of display by glancing down through the sunglasses. The more important effect is that not only is the light from the display not attenuated, any polarized light from the display which would ordinarily be extinguished by cross polarization does not occur due to the fact that the density of the dye on the oriented substrate which creates the polarization is slight or nonexistent. This in turn means that the sunglass lens at the bottom is virtually transparent.

In summary, a technique is utilized to form a continuous web of gradient polarized film having a gradient polarization density so as to be able to manufacture polarized sunglasses with a gradient polarized film characteristic. Alternatively, the gradient density polarized film may be used for any optical application.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of apparatus including a bath and a web transport for providing a continuous process for manufacturing an oriented web with a gradient polarization characteristic;

FIG. 2 is a diagrammatic illustration of the apparatus of FIG. 1 for extending the residence time of the web in the bath, also showing agitating means for preventing striations;

FIG. 3 is a diagrammatic illustration of the varying residence time of portions of the web of FIGS. 1 and 2 in the bath so as to impart a gradient polarization characteristic for the film produced.

### DETAILED DESCRIPTION

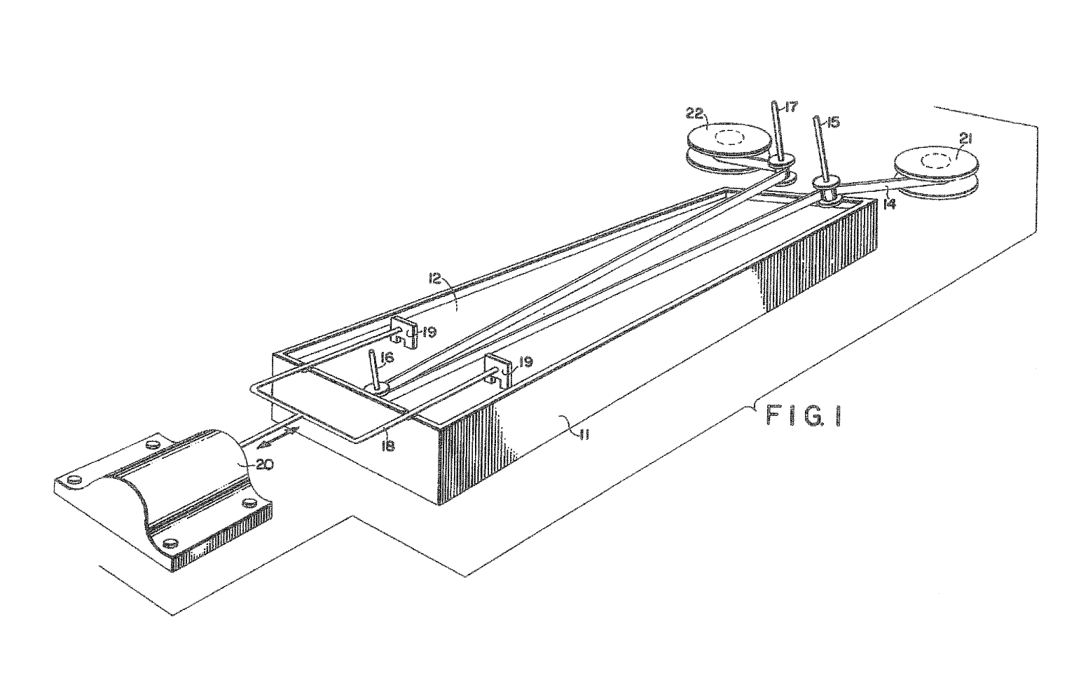

In order to be able to provide a polarized sheet in a continuous process and referring now to FIG. 1, the apparatus of the subject invention generally comprises a dye bath container and associated web transport equipment as depicted.

Here it can be seen that a dye bath container 11 which is adapted to retain dye bath 12, is associated with means for conducting a web 14 longitudinally into dye bath container 11 and progressively transversely submerging the web 14 into dye bath 12, and conducting web 14 out of dye bath 12. These conductive means generally comprise adjustable spools 15, 16 and 17. There is also shown means for producing waves on the surface of the dye bath. Such wave producing means comprise a frame 18, paddles 19 attached to a frame 18, and means 20 attached to frame 18 for moving frame 18 and attached paddles 19 in a reciprocating manner. The dye bath container may be provided with heating means (not shown). The dye bath material itself comprises either a solution or dispersion of a dye which is deposited upon an oriented sheet for causing the sheet to have a polarization characteristic. The preferred dyes in the subject invention are for instance iodine-based dyes or dichroic dyes commonly used for manufacturing of polarized films. The web in one embodiment is a molecularly oriented polyvinyl alcohol web which is to be dyed with iodine or a dichroic dye whose molecules react with the oriented sheet to provide for the required polarization.

For providing a polarized film, web 14 preferably comprises a continuous flexible sheet of oriented material having a transverse or widthwise dimension small relative to its longitudinal or lengthwise direction. The top and bottom edges are substantially parallel. In a preferred embodiment the transverse dimension may be, for an example, approximately 5 to 10 cm while the longitudinal dimension, may be several hundred meters. Preferably this flexible web will comprise a transparent oriented material that when stained provides for the required polarization effect. Initially the material will be provided on a supply spool 21, threaded through conducting or transport means and onto a take-up spool 22.

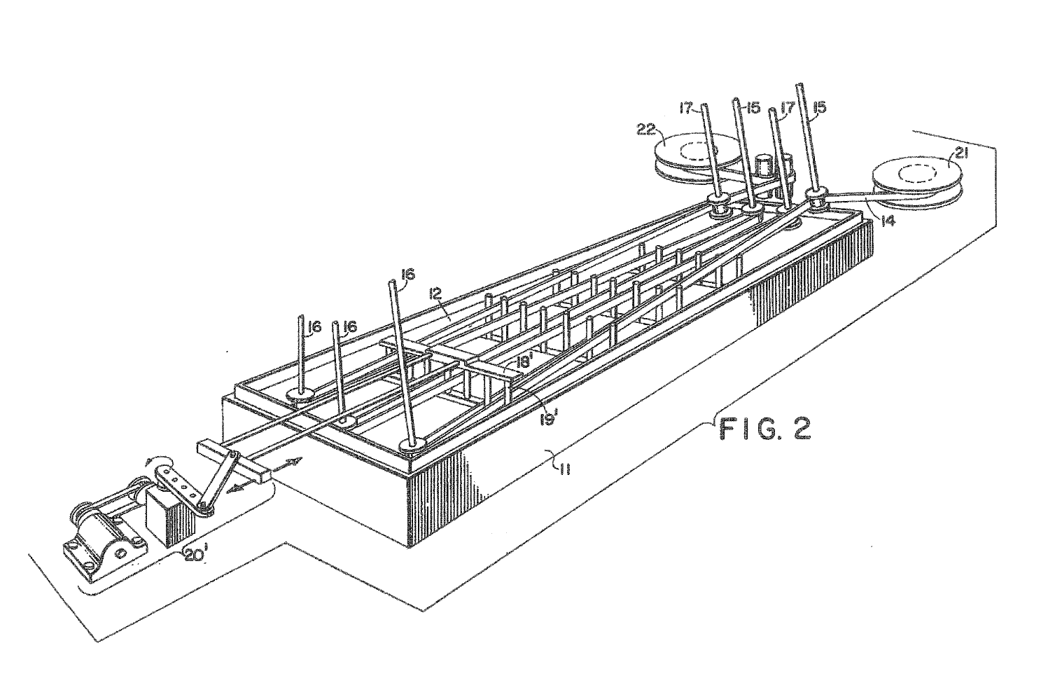

Referring now to FIG. 2, this figure shows an embodiment of the subject invention wherein additional adjustable transport means conduct the web progressively transversely into and out of the dye bath three times before conducting the web onto tape up spool 22. Obviously, the density gradient of the dye may be controlled by precisely adjusting the residence times of progressive transverse points of the web in the dye bath.

In operation, a spool containing a web of oriented material to be died is fixed in a position adjacent dye bath 12 such that a plane through the longitudinal dimension of the web as it enters the dye bath is preferably substantially perpendicular to the surface of the bath and the top and bottom edges of the web are at small acute angle to the surface of the dye bath. This orientation results in the bottom edge of the web being progressively immersed into the bath as the web proceeds from the spool and then progressively causes it to emerge from the bath so that a differential transverse residence time is established for the web in the dye bath. This operation essentially comprises conducting the web progressively, transversely into the dye bath to a point of maximum submersion, then conducting the web out of the dye bath.

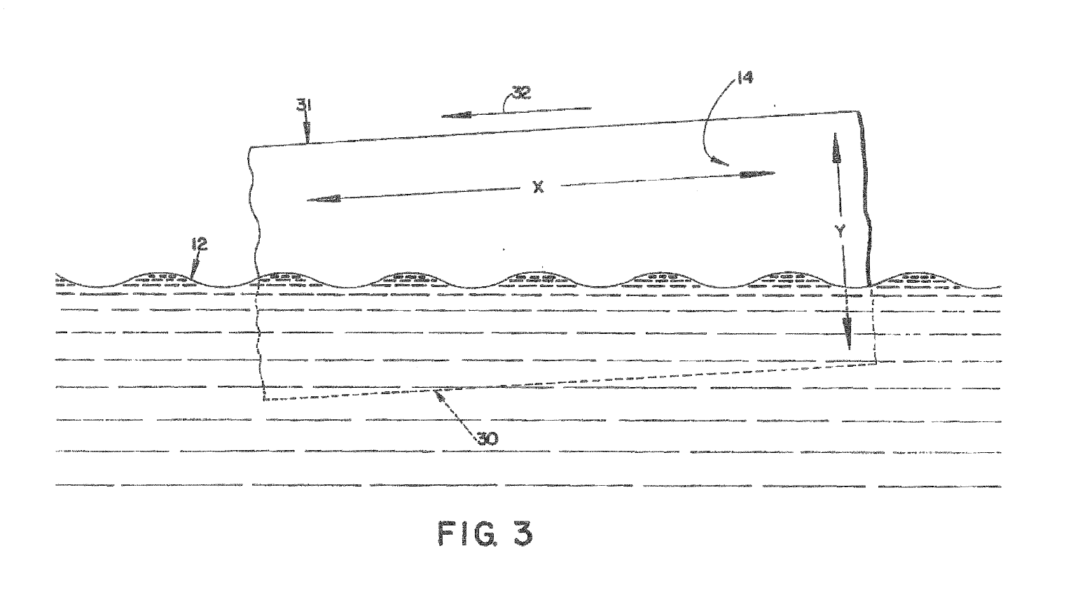

Referring to FIG. 3, there is depicted a side view of a section of web 14 entering dye bath 12 in the direction indicated by arrow 32. The bottom edge 30 of the web enters the dye bath at an angle acute to the average surface of the dye bath. Top edge 31 is essentially parallel to bottom to the bottom edge. It can be seen that those points on the web near the bottom edge have a longer residence time in a dye bath and do those points further away from the bottom edge, closer to the top edge. X and Y denote, respectively, the longitudinal and transverse dimensions of the web.

The amount of dying at any point in the web is directly related to the time of exposure of that point to the dye bath material in the dye bath container, i.e. the residence time of that point in the bath. For a given transverse segment, those points exposed to the dye bath for a longer residence time, that is, those points first submerged into the dye bath and last removed from the dye bath, have a greater exposure to the dying material and have more dye absorbed than those points having a shorter rest time. The progression of points on a given transverse segment, starting in one edge of these that segment and moving to the other edge with the residence time hearing constantly from one point to the next will result in a dye density gradient on that transverse segment.

It is important in producing a dye density gradient on the web that a smooth gradient is obtained and therefore it is important that there be introduced no striations indicating an abrupt change in density. Such striations can be avoided by disturbing the surface of the dye bath, for instance, by creating waves on the surface. These waves may be produced, for instance, by paddles 19 attached to means for moving the paddles back and forth in the dye bath. Such means are shown in the figures as the frame 18 and means 20 for moving the frame in a reciprocating manner. The waves, so set up, introduce a constant changing but rather random surface configuration that make possible avoidance of for instance of striations that might be introduced and destroy the smooth gradient.

In summary, a method and apparatus is provided for continuously forming a web having a gradient polarization characteristic for use in sunglasses or other optical applications that includes drawing a vertically oriented web of molecularly oriented material through a dye bath at an angle to the bath such that the residency time in the bath varies from top to bottom of the web to establish a polarization gradient from 100% at the top of the web to close to 0% at the bottom of the web. This process also creates a minimum transmissivity at the top of the web and a maximum transmissivity at the bottom of the web for permitting viewing displays using sunglasses having lenses cut from the web by viewing a display through the bottom portion of the sunglass lenses.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for preparing a gradient polarized sheet comprising the steps of:
providing a web of molecularly oriented material having a relatively small transverse dimension and top and bottom substantially parallel longitudinal edges;
conducting the web into a bath of dye that has molecules that associate with the molecularly oriented molecules in the web to give the web a polarization characteristic such that the transverse plane through the longitudinal dimension of the web makes substantially a right angle with the plane of the surface of the dye bath, with the bottom longitudinal edge of the web entering the dye bath at an acute angle to the surface of the dye bath so that the web is at least partially progressively immersed in the dye bath; and,
drawing the web through the dye bath so as to conduct the web through the dye bath and out of the dye bath to impart a transverse dye density gradient and thus a transverse polarization gradient to the deposited dye that is a function of the residence time of various portions of the web in the dye bath, thereby to establish a gradient polarization characteristic for the sheet.

2. The method of claim 1, wherein the web is used to provide lens stock from which lenses can be cut.

3. The method of claim 2, wherein said lenses have upper and lower portions and wherein the lenses are used in sunglasses.

4. The method of claim 3, wherein the sunglasses are provided with a polarization gradient that establishes maximum polarization at the upper portion of the lenses and minimum polarization at the lower portion of the lenses, whereby objects at a distance may be viewed through the polarized upper portion of the lenses and whereby displays may be viewed through the lower portions of the lenses so that the displays are viewed without light attenuation due to the lack of dye at the lower portions of the lenses.

5. The method of claim 4, wherein the displays are polarized and wherein the displays may be viewed through the bottom portions of the lenses unattenuated by cross polarization.

6. The method of claim 1, wherein the web has close to 100% polarization at the top longitudinal edge thereof and close to 0% polarization at the bottom longitudinal edge thereof.

7. The method of claim 1, wherein the transmittance of the web at the top longitudinal edge thereof is at a maximum and wherein the transmittance of the web at the bottom longitudinal edge thereof is at a minimum to permit viewing of displays through sunglasses having lenses made from the web by viewing the displays relatively unattenuatedly through the bottom portions of the lenses.

8. The method of claim 7, wherein the displays are polarized such that viewing of the displays through the bottom portions of the lenses is made possible due to a lack of cross polarization at the bottom portion of the web.

9. The method of claim 1, wherein the density gradient is continuous.

10. A product made by the process of claim 1.

11. Sunglasses made by the process of claim 1.
